(19) United States
(12) Patent Application Publication
(10) Pub. No.: US 2023/0256541 A1
(43) Pub. Date: Aug. 17, 2023

(54) METHOD FOR MANUFACTURING DISSIMILAR MATERIAL JOINT STRUCTURE

(71) Applicant: Kabushiki Kaisha Kobe Seiko Sho (Kobe Steel, Ltd.), Kobe-shi (JP)

(72) Inventors: Kyohei MAEDA, Kanagawa (JP); Reiichi SUZUKI, Kanagawa (JP)

(73) Assignee: Kabushiki Kaisha Kobe Seiko Sho (Kobe Steel, Ltd.), Kobe-shi (JP)

(21) Appl. No.: 18/004,058

(22) PCT Filed: Jun. 28, 2021
(86) PCT No.: PCT/JP2021/024387

§ 371 Date: Dec. 31, 2022

(30) Foreign Application Priority Data
Jul. 8, 2020 (JP) 2020-117997

(51) Int. Cl. B23K 26/323; B23K 26/073; B23K 26/322; B23K 26/06

(52) U.S. Cl. CPC B23K 26/323; B23K 26/322; B23K 26/0648; B23K 26/0734; B23K 2103/20

(57) ABSTRACT

A method for manufacturing a dissimilar material joint structure by joining a steel material and an aluminum or aluminum alloy material having a low-temperature spray coating made of a metal powder capable of being joined to the steel material on at least a part of a surface of the aluminum or aluminum alloy material. The method includes overlapping the aluminum or aluminum alloy material and the steel material such that the low-temperature spray coating and the steel material face each other and emitting a laser beam from a steel material side. Where a region to be irradiated with the laser beam includes a first region where at least the steel material and the low-temperature spray coating are melted, and a second region where the steel material and the low-temperature spray coating are not melted in a peripheral portion of the first region.

### TECHNICAL FIELD

The present invention relates to a method for manufacturing a dissimilar material joint structure, which is a method for laser welding an aluminum or aluminum alloy material having a low-temperature spray coating formed on a surface thereof and a steel material.

Hereinafter, the aluminum or aluminum alloy material may be collectively referred to simply as an “aluminum alloy material”.

### BACKGROUND ART

In recent years, in order to reduce the weight of a vehicle body for the purpose of reducing the amount of CO₂ emissions and to enhance collision safety, a high tensile strength steel (HTSS) sheet has been applied to a body frame of an automobile or the like.

In addition, for the purpose of further reducing the weight of the vehicle body, there is a high demand for a dissimilar metal joining material obtained by joining a lightweight aluminum alloy material and a steel material. As a method for joining dissimilar metals, there is generally a method of joining dissimilar metals with a nail, a screw, or the like. However, since the nail or the screw is relatively expensive, there is a problem in that the manufacturing cost of the joining material increases, and the resulting joining material becomes heavy with the weight of the nail or the screw.

On the other hand, when an aluminum alloy material and a steel material are directly welded by a general method, a brittle intermetallic compound is formed at a joining interface, and a good strength cannot be obtained. Therefore, there is a demand for a welding technique by which a high strength can be obtained in the joining between an aluminum alloy material and a steel material.

As a method for joining dissimilar metals by welding, Patent Literature 1 discloses a joining method in which at least one metal powder selected from pure iron, carbon steel, nickel, a nickel alloy, cobalt, and a cobalt alloy is sprayed at a low temperature onto at least a part of a surface of an aluminum alloy material, the aluminum alloy material and a steel material are overlapped such that the obtained low-temperature spray coating and the steel material face each other, and laser welding is performed from a steel material side.

### CITATION LIST

### Patent Literature

Patent Literature 1: JP2020-11276A

### SUMMARY OF INVENTION

### Technical Problem

However, when penetration by laser welding reaches an aluminum alloy material, there is a problem in that a crack is likely to occur particularly in a heat affected zone (HAZ) of a low-temperature spray coating.

The present invention has been made in view of the problems described above, and an object thereof is to provide a method for manufacturing a dissimilar material joint structure, by which occurrence of a crack in a HAZ can be prevented in dissimilar material joining between an aluminum or aluminum alloy material and a steel material.

### Solution to Problem

A method for manufacturing a dissimilar material joint structure according to the present invention includes the configurations of the following (1).

(1) A method for manufacturing a dissimilar material joint structure by joining a steel material and an aluminum or aluminum alloy material having a low-temperature spray coating made of a metal powder capable of being joined to the steel material on at least a part of a surface of the aluminum or aluminum alloy material, the method including:
overlapping the aluminum or aluminum alloy material and the steel material such that the low-temperature spray coating and the steel material face each other; and
emitting a laser beam from a steel material side, in which
a region to be irradiated with the laser beam includes a first region where at least the steel material and the low-temperature spray coating are melted, and a second region where the steel material and the low-temperature spray coating are not melted in a peripheral portion of the first region.

A preferred embodiment of the method for manufacturing a dissimilar material joint structure according to the present invention includes the configurations of the following (2) to (8).

(2) The method for manufacturing a dissimilar material joint structure according to (1), in which the second region includes a heat affected zone of the steel material and the low-temperature spray coating.

(3) The method for manufacturing a dissimilar material joint structure according to (1), in which the first region is a region, to be irradiated with a part of the laser beam, where the steel material, the low-temperature spray coating, and the aluminum or aluminum alloy material are melted, and the second region is a region where the steel material, the low-temperature spray coating, and the aluminum or aluminum alloy material are not melted.

(4) The method for manufacturing a dissimilar material joint structure according to (3), in which the second region includes a heat affected zone of the steel material, the low-temperature spray coating, and the aluminum or aluminum alloy material.

(5) The method for manufacturing a dissimilar material joint structure according to any one of (1) to (4), in which an intensity distribution of the laser beam has a first peak having a highest beam intensity in the first region, and has at least one annular second peak centered on the first peak in the second region.

(6) The method for manufacturing a dissimilar material joint structure according to any one of (1) to (4), in which an intensity of the laser beam is highest in the first region, and decreases stepwise in the second region as a distance from the first region increases.

(7) The method for manufacturing a dissimilar material joint structure according to any one of (1) to (6), in which the metal powder contains at least one selected from pure iron, carbon steel, stainless steel, nickel, a nickel alloy, cobalt, and a cobalt alloy.

(8) The method for manufacturing a dissimilar material joint structure according to any one of (1) to (7), in which the laser beam is obtained by one selected from a ring mode using a diffractive optical element, a double fiber, or a conical condensing lens, defocus, and infocus.

### Advantageous Effects of Invention

According to the present invention, it is possible to provide a method for manufacturing a dissimilar material joint structure, by which occurrence of a crack in a HAZ can be prevented in dissimilar material joining between an aluminum alloy material and a steel material.

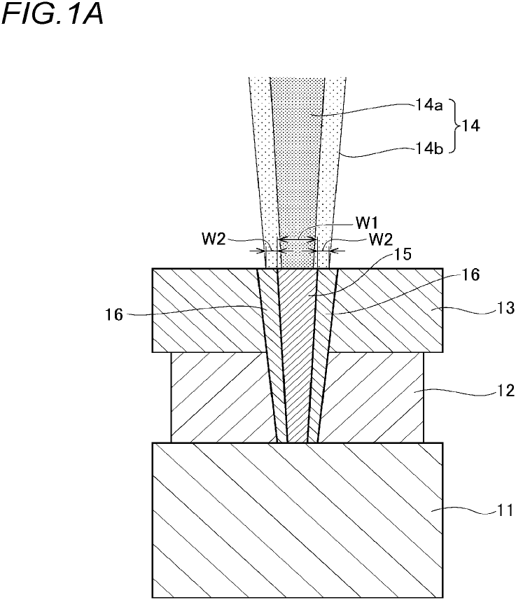

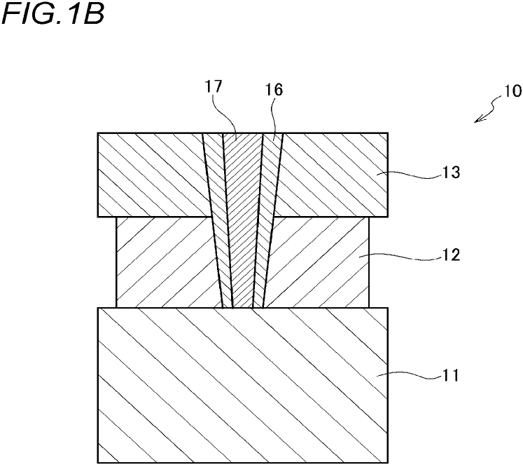

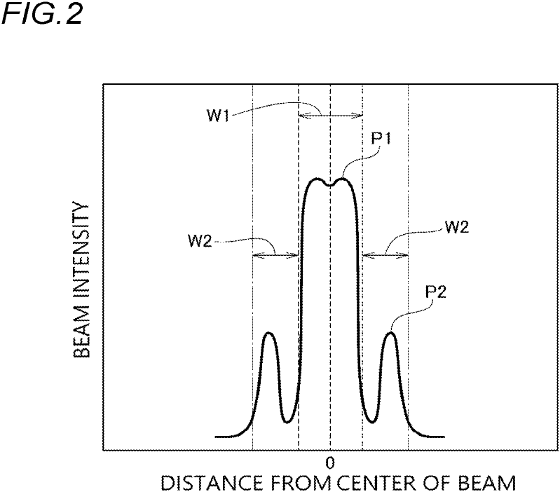

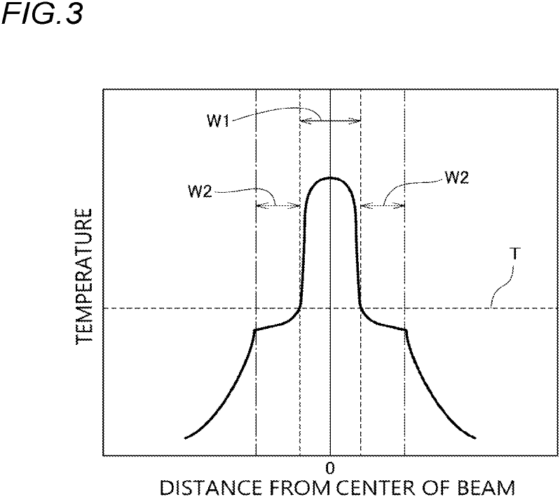

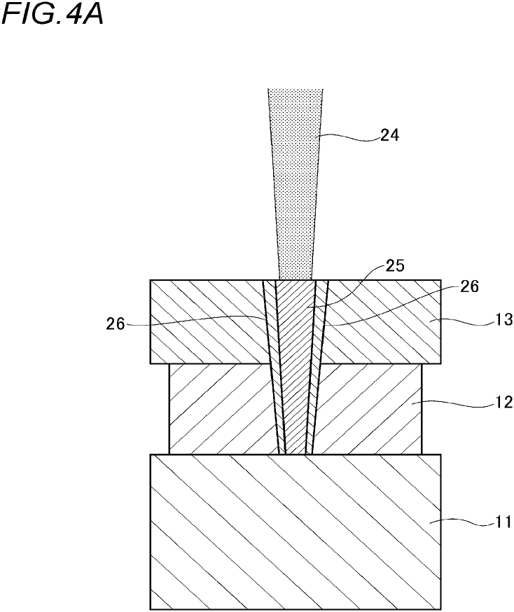

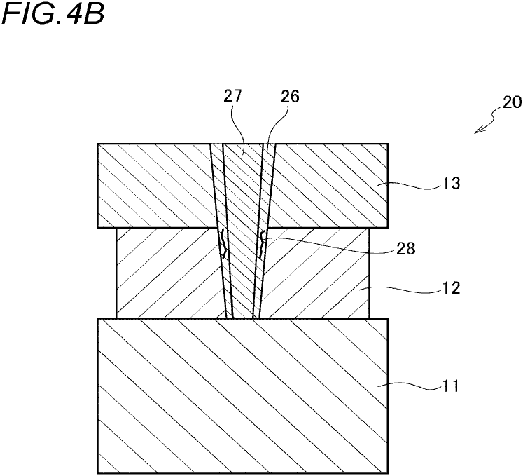

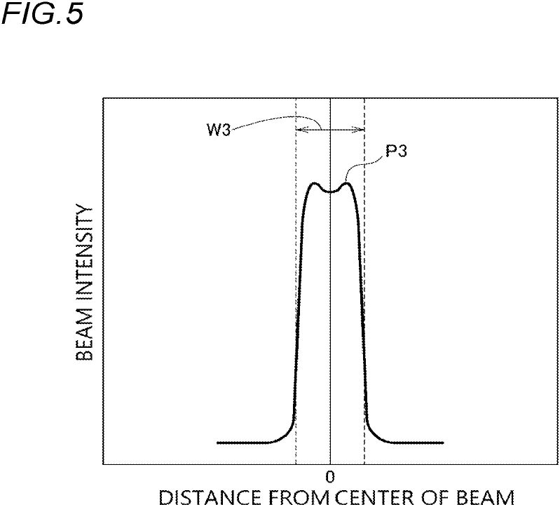

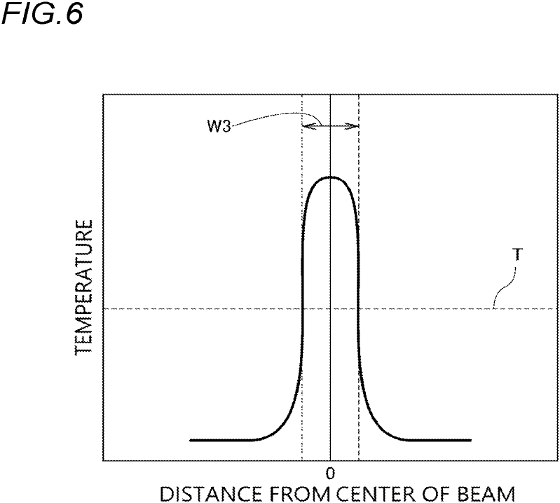

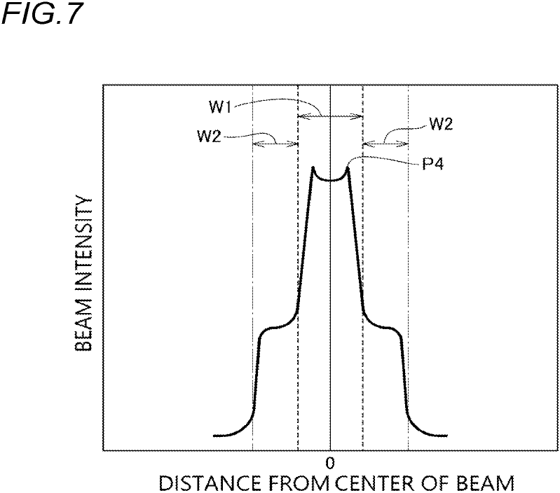

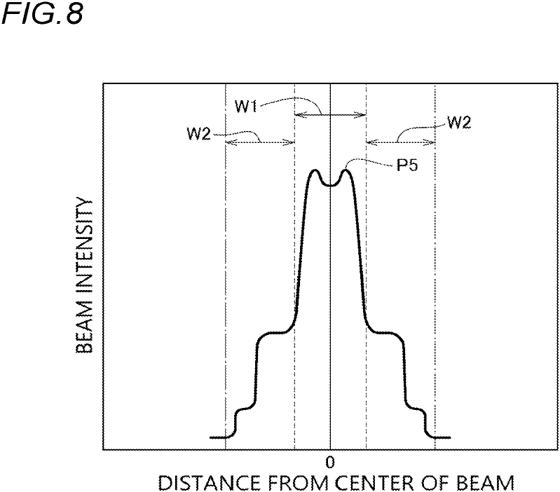

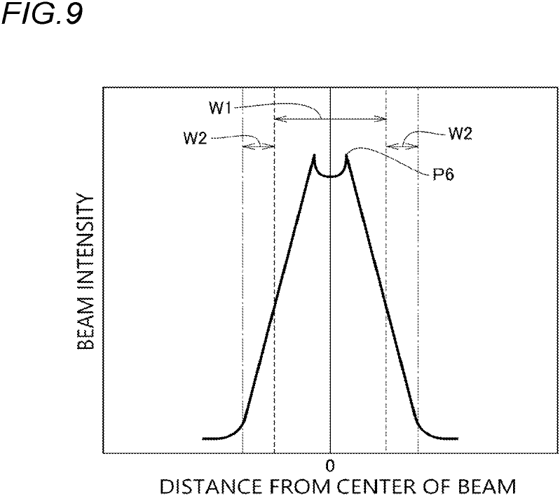

### BRIEF DESCRIPTION OF DRAWINGS

[FIG. 1A] FIG. 1A is a schematic cross-sectional view showing a method for manufacturing a dissimilar material joint structure according to a first embodiment of the present invention, and is a view showing emitting a laser beam.

[FIG. 1B] FIG. 1B is a schematic cross-sectional view showing the method for manufacturing a dissimilar material joint structure according to the first embodiment of the present invention, and is a view showing a manufactured dissimilar material joint structure.

[FIG. 2] FIG. 2 is a graph schematically showing an intensity distribution of the laser beam in the first embodiment when a vertical axis represents a beam intensity and a horizontal axis represents a distance from a center of the beam.

[FIG. 3] FIG. 3 is a graph schematically showing a temperature distribution of a low-temperature spray coating in the first embodiment when a vertical axis represents a temperature and a horizontal axis represents the distance from the center of the beam.

[FIG. 4A] FIG. 4A is a schematic cross-sectional view showing a related-art method for manufacturing a dissimilar material joint structure, and is a view showing emitting a laser beam.

[FIG. 4B] FIG. 4B is a schematic cross-sectional view showing the related-art method for manufacturing a dissimilar material j oint structure, and is a view showing a manufactured dissimilar material joint structure.

[FIG. 5] FIG. 5 is a graph schematically showing an intensity distribution of the laser beam in the related-art manufacturing method when a vertical axis represents a beam intensity and a horizontal axis represents a distance from a center of the beam.

[FIG. 6] FIG. 6 is a graph schematically showing a temperature distribution of a low-temperature spray coating in the related-art manufacturing method when a vertical axis represents a temperature and a horizontal axis represents the distance from the center of the beam.

[FIG. 7] FIG. 7 is a graph schematically showing an intensity distribution of a laser beam in a second embodiment when a vertical axis represents a beam intensity and a horizontal axis represents a distance from a center of the beam.

[FIG. 8] FIG. 8 is a graph schematically showing an intensity distribution of a laser beam in a third embodiment when a vertical axis represents a beam intensity and a horizontal axis represents a distance from a center of the beam.

[FIG. 9] FIG. 9 is a graph schematically showing an intensity distribution of a laser beam in a fourth embodiment when a vertical axis represents a beam intensity and a horizontal axis represents a distance from a center of the beam.

### DESCRIPTION OF EMBODIMENTS

Hereinafter, embodiments of the present invention will be described in detail. It should be noted that the present invention is not limited to the embodiments described below, and can be optionally changed without departing from the gist of the present invention.

The present inventors have conducted intensive studies to obtain a method by which a crack occurring in a HAZ can be prevented in dissimilar material joining between an aluminum alloy material and a steel material. As a result, the present inventors have found that in order to prevent rapid heat or rapid cooling of a HAZ, it is effective to irradiate, with a laser beam, a peripheral portion of a region where a steel material and a low-temperature spray coating melt to obtain a temperature at which the steel material and the low-temperature spray coating are not melted.

That is, a method for manufacturing a dissimilar material joint structure according to an embodiment is a method for manufacturing a dissimilar material joint structure by joining a steel material and an aluminum or aluminum alloy material having a low-temperature spray coating made of a metal powder capable of being joined to the steel material on at least a part of a surface of the aluminum or aluminum alloy material, the method including overlapping the aluminum or aluminum alloy material and the steel material such that the low-temperature spray coating and the steel material face each other, and emitting a laser beam from a steel material side. A region to be irradiated with the laser beam includes a first region where at least the steel material and the low-temperature spray coating are melted, and a second region where the steel material and the low-temperature spray coating are not melted in a peripheral portion of the first region.

Hereinafter, a method for manufacturing a dissimilar material joint structure according to an embodiment of the present invention will be described in detail.

### First Embodiment

FIGS. 1A and 1B are schematic cross-sectional views showing a method for manufacturing a dissimilar material joint structure according to a first embodiment of the present invention. As shown in FIG. 1A, a low-temperature spray coating 12 is formed on at least a part of a surface of an aluminum alloy material 11 by a low-temperature spray method (a cold spray method) of blowing a metal powder containing, for example, pure iron. The cold spray method refers to a method for forming the low-temperature spray coating 12 by blowing a gas and a metal powder to an object at a high speed equal to or higher than sound velocity. This method can be performed by appropriately selecting a type of a gas, a pressure, a temperature, a particle diameter of a metal powder, and the like to be used.

Then, the aluminum alloy material 11 and a steel material 13 are disposed so as to be overlapped with each other such that the low-temperature spray coating 12 and the steel material 13 face each other, and a laser beam 14 is emitted from a steel material 13 side to form a molten portion 15.

Thereafter, as shown in FIG. 1B, the irradiation with the laser beam 14 is stopped and cooling is performed to form a weld metal 17 extending from the steel material 13 to the low-temperature spray coating 12, and a dissimilar material joint structure 10 in which the aluminum alloy material 11 and the steel material 13 are joined is manufactured.

In the present embodiment, a center beam 14a forming the molten portion 15 and a ring beam 14b applying desired heat to a peripheral portion of the molten portion 15 are generated by a ring mode using, for example, a double fiber, and the laser beam 14 is implemented by the center beam 14a and the ring beam 14b. The ring mode refers to a means by which two coaxial laser beams (the center beam 14a and the ring beam 14b) can be obtained at the same time, and beam intensities of the laser beams can be controlled individually.

An intensity of the laser beam 14 and a temperature of the low-temperature spray coating 12 at a focal point when the laser beam 14 is emitted from the steel material 13 side will be described below.

FIG. 2 is a graph schematically showing an intensity distribution of the laser beam in the first embodiment when a vertical axis represents a beam intensity and a horizontal axis represents a distance from a center of the beam. FIG. 3 is a graph schematically showing a temperature distribution of the low-temperature spray coating in the first embodiment when a vertical axis represents a temperature and a horizontal axis represents the distance from the center of the beam.

As shown in FIG. 2, a first peak P1 having a highest beam intensity is generated in a first region W1 irradiated with the center beam 14a, and an annular second peak P2 centered on the first peak P1 is generated in a peripheral portion of the first peak P1, that is, in a second region W2 irradiated with the ring beam.

When a profile of the intensity distribution of the laser beam is as shown in FIG. 2, the low-temperature spray coating 12 has the temperature distribution as shown in FIG. 3. That is, the first region W1 irradiated with the center beam 14a has a temperature equal to or higher than a melting point T of the low-temperature spray coating 12, and the second region W2 irradiated with the ring beam 14b has a temperature that does not exceed the melting point T of the low-temperature spray coating 12.

When melting points of the steel material 13 and the low-temperature spray coating 12 are different from each other, a laser welding condition is controlled such that the center beam 14a melts the steel material 13 and the low-temperature spray coating 12, and a laser welding condition is controlled such that the ring beam 14b does not melt either the steel material 13 or the low-temperature spray coating 12.

According to the manufacturing method in the first embodiment as described above, the low-temperature spray coating 12 is formed on the surface of the aluminum alloy material 11 by the cold spray method, and thus fine irregularities are formed on the surface of the aluminum alloy material 11 due to a large amount of metal powder. Therefore, the low-temperature spray coating 12 and the aluminum alloy material 11 are mechanically and firmly joined to each other by an anchor effect.

The low-temperature spray coating 12 made of a metal powder that can be joined to a steel material, such as pure iron, can be easily joined to the steel material 13 by laser welding, and thus the dissimilar material joint structure 10 of the aluminum alloy material 11 and the steel material 13 can be manufactured.

Further, the second region W2 irradiated with the ring beam 14b includes at least a part of a HAZ 16 of the steel material 13 and the low-temperature spray coating 12, and has a temperature rising within a range in which neither the steel material 13 nor the low-temperature spray coating 12 is melted. An irradiation condition of the ring beam 14b varies depending on a type of the low-temperature spray coating 12, and thus is not particularly limited as long as the irradiation condition is a condition under which the steel material 13 and the low-temperature spray coating 12 are not melted, and it is preferable to adjust a temperature gradient so as to decrease from the molten portion 15 of the low-temperature spray coating 12 to the steel material 13 and the low-temperature spray coating 12 around the molten portion 15 via the HAZ 16. Accordingly, occurrence of a crack in the HAZ 16 can be prevented.

In the first embodiment, an example in which one annular second peak P2 is present in the second region W2 has been described, and a plurality of annular peaks may be present as long as a temperature of the second region W2 is a temperature at which the steel material 13 and the low-temperature spray coating 12 are not melted, and is controlled such that rapid heat or rapid cooling of the HAZ 16 can be prevented.

As described above, as laser welding conditions for controlling temperatures and laser irradiation ranges in the first region and the second region, a heat source, an output, a travel speed, a weld diameter, and the like can be appropriately selected.

### Related-Art Method for Manufacturing Dissimilar Material Joint Structure

For comparison, an example in which only a laser beam for melting a steel material and a low-temperature spray coating is emitted will be described.

FIGS. 4A and 4B are schematic cross-sectional views showing a related-art method for manufacturing a dissimilar material joint structure. FIG. 5 is a graph schematically showing an intensity distribution of a laser beam in the related-art manufacturing method when a vertical axis represents a beam intensity and a horizontal axis represents a distance from a center of the beam. FIG. 6 is a graph schematically showing a temperature distribution of a low-temperature spray coating in the related-art manufacturing method when a vertical axis represents a temperature and a horizontal axis represents the distance from the center of the beam.

In FIGS. 4A and 4B, the same or equivalent parts as those in the first embodiment are denoted by the same reference numerals, and a description thereof will be omitted or simplified.

As shown in FIG. 4A, the aluminum alloy material 11 on which the low-temperature spray coating 12 is formed and the steel material 13 are disposed so as to be overlapped with each other such that the low-temperature spray coating 12 and the steel material 13 face each other, and a laser beam 24 is emitted from the steel material 13 side to form a molten portion 25. At this time, a HAZ 26 is generated around the molten portion 25.

Thereafter, as shown in FIG. 4B, the irradiation with the laser beam 24 is stopped and cooling is performed to form a weld metal 27 extending from the steel material 13 to the low-temperature spray coating 12, and a dissimilar material joint structure 20 in which the aluminum alloy material 11 and the steel material 13 are joined is manufactured.

As shown in FIG. 5, in the related-art method for manufacturing the dissimilar material joint structure 20, a peak P3 is generated only in a region W3 irradiated with the laser beam 24, and a peripheral portion of the region W3 is not irradiated with the laser beam 24, and has no peak. Therefore, as shown in FIG. 6, a temperature in the region W3 is equal to or higher than the melting point T of the low-temperature spray coating 12, and the molten portion 25 is formed. However, no heat is applied to the other regions, and there is no increase in temperature.

In the related-art method for manufacturing the dissimilar material joint structure 20 described above, the molten portion 25 formed by irradiation with the laser beam 24 exceeds melting temperatures of the steel material 13 and the low-temperature spray coating 12, and is extremely high in temperature. In the HAZ 26, a large temperature difference occurs between the molten portion 25 and the other portions, and strain occurs due to rapid heat or rapid cooling, and thus a crack 28 occurs.

In contrast, in the first embodiment, as described above, the second region W2 is also irradiated with the laser beam 14, and as shown in FIG. 1A, the HAZ 16 is generated that is wider than the HAZ 26 generated by the related-art manufacturing method. Therefore, in the first embodiment, a temperature gradient in the HAZ 16 can be made smaller than that in the related-art manufacturing method, whereby the occurrence of the crack can be prevented.

### Second Embodiment

Next, a method for manufacturing a dissimilar material joint structure according to a second embodiment will be described. Since manufacturing steps in second to fourth embodiments described below are the same as those in the first embodiment, the manufacturing steps in the second and subsequent embodiments will be omitted with reference to FIGS. 1A and 1B, and only a laser beam irradiation method will be described in detail.

FIG. 7 is a graph schematically showing an intensity distribution of a laser beam in the second embodiment when a vertical axis represents a beam intensity and a horizontal axis represents a distance from a center of the beam.

Also in the second embodiment, similarly to the first embodiment, a ring mode laser using, for example, a double fiber is used. Specifically, a condition such as an intensity of the center beam 14a is controlled such that a peak P4 having a highest beam intensity is generated in the first region W1 irradiated with the center beam 14a, and a temperature of the first region W1 is equal to or higher than a temperature at which the steel material 13 and the low-temperature spray coating 12 are melted. In addition, a condition such as an intensity of the ring beam 14b is controlled such that the second region W2 irradiated with the ring beam 14b has a temperature at which neither the steel material 13 nor the low-temperature spray coating 12 is melted. Unlike the first embodiment, no peak is generated in the second region W2, and a portion showing a constant intensity regardless of the distance from the center of the beam and a portion where the intensity decreases as the distance from the center of the beam increases are generated. That is, in the second region W2, a beam intensity decreases stepwise as a distance from the first region W1 increases.

Also in the manufacturing method according to the second embodiment described above, the second region W2 includes at least a part of the HAZ 16 of the steel material 13 and the low-temperature spray coating 12, and has a temperature rising within a range in which neither the steel material 13 nor the low-temperature spray coating 12 is melted. Therefore, the HAZ 16 is wider, and a temperature gradient is smaller from the molten portion 15 to the steel material 13 and the low-temperature spray coating 12 around the molten portion 15 via the HAZ 16, and thus occurrence of a crack due to rapid heat or rapid cooling can be prevented.

### Third Embodiment

FIG. 8 is a graph schematically showing an intensity distribution of a laser beam in the third embodiment when a vertical axis represents a beam intensity and a horizontal axis represents a distance from a center of the beam.

In the third embodiment, similarly to the second embodiment, a ring mode laser using, for example, a double fiber is used, and a peak P5 having a highest beam intensity is generated in the first region W1 irradiated with the center beam 14a. A condition such as an intensity of the center beam 14a is controlled such that the first region W1 has a temperature equal to or higher than a temperature at which the steel material 13 and the low-temperature spray coating 12 are melted, and a condition such as an intensity of the ring beam 14b is controlled such that the second region W2 has a temperature at which neither the steel material 13 nor the low-temperature spray coating 12 is melted. A peak intensity in the second region W2 decreases stepwise as the distance from the center of the beam increases as in the second embodiment, and a difference from the second embodiment is that the peak intensity decreases stepwise in multiple stages.

Also in the manufacturing method according to the third embodiment described above, the second region W2 includes at least a part of the HAZ 16 of the steel material 13 and the low-temperature spray coating 12, and has a temperature rising within a range in which neither the steel material 13 nor the low-temperature spray coating 12 is melted. Therefore, the HAZ 16 is wider, and a temperature gradient is smaller from the molten portion 15 to the steel material 13 and the low-temperature spray coating 12 around the molten portion 15 via the HAZ 16, and thus occurrence of a crack due to rapid heat or rapid cooling can be prevented.

In the first to third embodiments, the ring mode using the double fiber is used, and in addition, the center beam 14a and the ring beam 14b can be generated by a ring mode using a diffractive optical element (DOE), a conical condensing lens, or the like.

### Fourth Embodiment

FIG. 9 is a graph schematically showing an intensity distribution of a laser beam in the fourth embodiment when a vertical axis represents a beam intensity and a horizontal axis represents a distance from a center of the beam.

In the fourth embodiment, for example, the laser beam 14 based on defocus is used. Specifically, the beam is focused on a welding head (not shown) side rather than a surface of the steel material 13, and a beam intensity is controlled so as to obtain a broad intensity distribution as shown in FIG. 5. Also in the fourth embodiment in which the laser beam 14 based on defocus is used, a peak P6 having a highest beam intensity is generated in the first region W1, and in the second region W2, a beam intensity decreases stepwise as a distance from the first region W1 increases. A condition such as an intensity of the laser beam 14 is controlled such that the first region W1 has a temperature equal to or higher than a temperature at which the steel material 13 and the low-temperature spray coating 12 are melted, and the second region W2 has a temperature at which neither the steel material 13 nor the low-temperature spray coating 12 is melted.

Also in the manufacturing method according to the fourth embodiment described above, the second region W2 includes at least a part of the HAZ 16 of the steel material 13 and the low-temperature spray coating 12, and has a temperature rising within a range in which neither the steel material 13 nor the low-temperature spray coating 12 is melted. Therefore, the HAZ 16 is wider, and a temperature gradient is smaller from the molten portion 15 to the steel material 13 and the low-temperature spray coating 12 around the molten portion 15 via the HAZ 16, and thus occurrence of a crack due to rapid heat or rapid cooling can be prevented.

In the fourth embodiment, the defocus is used in order to make the beam intensity have a broad intensity distribution, and it is also possible to use infocus in which a beam is focused on an aluminum alloy material 11 side rather than the surface of the steel material 13. A degree to which a focus is shifted is not particularly limited, and a distance L1 from the surface of the steel material 13 to the focus is preferably 1% to 5% of a distance L2 from the welding head to the surface of the steel material 13 regardless of whether the focus is on a welding head side or on the steel material 13 side.

In the first to fourth embodiments, as shown in FIGS. 1A and 1B, the laser beam 14 is controlled such that the molten portion 15 does not reach the aluminum alloy material 11, and an irradiation condition of the laser beam 14 may be controlled such that the molten portion 15 reaches the aluminum alloy material 11. In this case, the irradiation condition of the laser beam 14 is preferably set such that the second region W2 includes a heat affected zone of the steel material 13, the low-temperature spray coating 12, and the aluminum alloy material 11.

In a case where laser welding is performed under a condition of deep penetration using the related-art manufacturing method, that is, in a case where a laser is emitted under a condition that the molten portion 15 reaches the aluminum alloy material 11, occurrence of a crack in a HAZ is remarkable, and thus the present invention is more suitable.

Subsequently, in the method for manufacturing a dissimilar material joint structure according to the present invention, the aluminum or aluminum alloy material, the metal powder used as a material of the low-temperature spray coating, and the steel material will be described in detail below.

### Aluminum or Aluminum Alloy Material

The aluminum or aluminum alloy material is not particularly limited, and an aluminum alloy material such as 2000 series, 5000 series, 6000 series, and 7000 series is preferably used from the viewpoint of strength when applied to a member used for an automobile or the like. In the present embodiment, laser welding in which welding performed by one-sided construction from a steel material side is enabled is used, so that an extruded material having a closed cross section, which is frequently used in the field of automobiles or the like, can be used without any problem.

### Metal Powder

In the present invention, the steel material and the low-temperature spray coating are joined by laser welding, and thus the metal powder that can be joined to the steel material is used as the material of the low-temperature spray coating. As such a metal powder, for example, a metal powder containing at least one selected from pure iron, carbon steel, stainless steel, nickel, a nickel alloy, cobalt, and a cobalt alloy can be selected.

In the present description, pure iron is easily available for industrial use and represents an iron having a purity of 99.9 mass % or more. The carbon steel refers to a steel material containing iron and carbon as a main component and containing a trace amount of silicon, manganese, impurity phosphorus, sulfur, copper, and the like. As the nickel alloy, an alloy commonly called an inconel alloy, an incoloy alloy, or a hastelloy alloy, which mainly contains Ni and to which an appropriate amount of Mo, Fe, Co, Cr, Mn, or the like is added, can be used.

### Particle Diameter and Shape of Metal Powder

A particle diameter of the metal powder used as the material of the low-temperature spray coating is not particularly limited, and is, for example, preferably 20 µm or less, and more preferably 10 µm or less when a gas pressure of the cold spray is set to a low pressure condition of 1 MPa or less.

On the other hand, when the gas pressure is set to a high pressure condition of 1 MPa to 5 MPa, the particle diameter is, for example, preferably 100 µm or less, and more preferably 50 µm or less.

A particle shape of the metal powder is not particularly limited, and is preferably spherical from the viewpoint of fluidity.

### Type of Working Gas

A gas used in the cold spray is not particularly limited, and air, nitrogen, helium, or a mixed gas thereof is generally used. On the other hand, when the low-temperature spray coating is oxidized, the laser weldability may be adversely affected. Therefore, it is preferable to use nitrogen or helium as a type of the gas.

### Steel Material

The steel material is not particularly limited as long as the steel material is a member made of a metal generally called steel. However, in recent years, as a steel material used for a body frame of an automobile or the like, a high tensile strength steel material (a high tensile steel) or the like has been frequently used for the purpose of reducing the weight of a vehicle body and enhancing collision safety. It is difficult to apply a mechanical joining method widely used as a steel-aluminum dissimilar material joining method to a steel material having a tensile strength of 590 MPa or more. Therefore, the present invention is particularly effective in a high tensile strength steel material having a tensile strength of 590 MPa or more.

For example, JP2013-95974A discloses, as a method for forming a densified layer on a spray coating, a method of scanning and irradiating a surface of a spray coating with a preceding laser beam, and overlapping irradiation while scanning, with a following laser beam, an irradiation target region scanned with the preceding laser beam. JP2008-266724A discloses, as a surface treatment method of a spray coating, a method of melting and densifying a spray coating with a laser having a wavelength of 9 µm or more.

Both methods relate to a technique of modifying a surface of a spray coating by directly irradiating the surface of the spray coating with a laser, and there is no mention of a method for manufacturing a dissimilar material joint structure by overlapping an aluminum alloy material and a steel material such that a low-temperature spray coating and the steel material face each other, and performing laser welding from a steel material side as shown in the present invention. In addition, there is no mention of a crack in a heat affected zone at the time of laser irradiation, which is a problem to be solved by the present invention.

Although various embodiments have been described above with reference to the drawings, it is needless to say that the present invention is not limited to such examples. It is apparent to those skilled in the art that various changes and modifications can be conceived within the scope of the claims, and it is also understood that such changes and modifications belong to the technical scope of the present invention. Constituent elements in the embodiments described above may be combined freely within a range not departing from the spirit of the present invention.

The present application is based on Japanese Patent Application No. 2020-117997 filed on Jul. 8, 2020, and the contents thereof are incorporated herein by reference.

### REFERENCE SIGNS LIST

10, 20: dissimilar material joint structure
11: aluminum alloy material
12: low-temperature spray coating
13: steel material
14, 24: laser beam
14a: center beam
14b: ring beam
15, 25: molten portion
16, 26: HAZ
17, 27: weld metal
28: crack
P1: first peak
P2: second peak
T: melting point of low-temperature spray coating
W1: first region
W2: second region

1. A method for manufacturing a dissimilar material joint structure by joining a steel material and an aluminum or aluminum alloy material having a low-temperature spray coating made of a metal powder capable of being joined to the steel material on at least a part of a surface of the aluminum or aluminum alloy material, the method comprising:
overlapping the aluminum or aluminum alloy material and the steel material such that the low-temperature spray coating and the steel material face each other; and
emitting a laser beam from a steel material side,
wherein a region to be irradiated with the laser beam includes a first region where at least the steel material and the low-temperature spray coating are melted, and a second region where the steel material and the low-temperature spray coating are not melted in a peripheral portion of the first region.

2. The method for manufacturing a dissimilar material joint structure according to claim 1, wherein the second region includes a heat affected zone of the steel material and the low-temperature spray coating.

3. The method for manufacturing a dissimilar material joint structure according to claim 1, wherein the first region is a region to be irradiated with a part of the laser beam, where the steel material, the low-temperature spray coating, and the aluminum or aluminum alloy material are melted, and the second region is a region where the steel material, the low-temperature spray coating, and the aluminum or aluminum alloy material are not melted.

4. The method for manufacturing a dissimilar material joint structure according to claim 3, wherein the second region includes a heat affected zone of the steel material, the low-temperature spray coating, and the aluminum or aluminum alloy material.

5. The method for manufacturing a dissimilar material joint structure according to claim 1, wherein an intensity distribution of the laser beam has a first peak having a highest beam intensity in the first region, and has at least one annular second peak centered on the first peak in the second region.

6. The method for manufacturing a dissimilar material joint structure according to claim 1, wherein an intensity of the laser beam is highest in the first region, and decreases stepwise in the second region as a distance from the first region increases.

7. The method for manufacturing a dissimilar material joint structure according to claim 1, wherein the metal powder contains at least one selected from pure iron, carbon steel, stainless steel, nickel, a nickel alloy, cobalt, and a cobalt alloy.

8. The method for manufacturing a dissimilar material joint structure according to claim 1, wherein the laser beam is obtained by one selected from a ring mode using a diffractive optical element, a double fiber, or a conical condensing lens, defocus, and infocus.

9. The method for manufacturing a dissimilar material joint structure according to claim 2, wherein an intensity distribution of the laser beam has a first peak having a highest beam intensity in the first region, and has at least one annular second peak centered on the first peak in the second region.

10. The method for manufacturing a dissimilar material joint structure according to claim 3, wherein an intensity distribution of the laser beam has a first peak having a highest beam intensity in the first region, and has at least one annular second peak centered on the first peak in the second region.

11. The method for manufacturing a dissimilar material joint structure according to claim 4, wherein an intensity distribution of the laser beam has a first peak having a highest beam intensity in the first region, and has at least one annular second peak centered on the first peak in the second region.

12. The method for manufacturing a dissimilar material joint structure according to claim 2, wherein an intensity of the laser beam is highest in the first region, and decreases stepwise in the second region as a distance from the first region increases.

13. The method for manufacturing a dissimilar material joint structure according to claim 3, wherein an intensity of the laser beam is highest in the first region, and decreases stepwise in the second region as a distance from the first region increases.

14. The method for manufacturing a dissimilar material joint structure according to claim 4, wherein an intensity of the laser beam is highest in the first region, and decreases stepwise in the second region as a distance from the first region increases.

15. The method for manufacturing a dissimilar material joint structure according to claim 2, wherein the metal powder contains at least one selected from pure iron, carbon steel, stainless steel, nickel, a nickel alloy, cobalt, and a cobalt alloy.

16. The method for manufacturing a dissimilar material joint structure according to claim 3, wherein the metal powder contains at least one selected from pure iron, carbon steel, stainless steel, nickel, a nickel alloy, cobalt, and a cobalt alloy.

17. The method for manufacturing a dissimilar material joint structure according to claim 4, wherein the metal powder contains at least one selected from pure iron, carbon steel, stainless steel, nickel, a nickel alloy, cobalt, and a cobalt alloy.

18. The method for manufacturing a dissimilar material joint structure according to claim 2, wherein the laser beam is obtained by one selected from a ring mode using a diffractive optical element, a double fiber, or a conical condensing lens, defocus, and infocus.

19. The method for manufacturing a dissimilar material joint structure according to claim 3, wherein the laser beam is obtained by one selected from a ring mode using a diffractive optical element, a double fiber, or a conical condensing lens, defocus, and infocus.

20. The method for manufacturing a dissimilar material joint structure according to claim 4, wherein the laser beam is obtained by one selected from a ring mode using a diffractive optical element, a double fiber, or a conical condensing lens, defocus, and infocus.
